(19) United States
(12) Patent Application Publication
(10) Pub. No.: US 2012/0095972 A1
(43) Pub. Date: Apr. 19, 2012

(54) System and Method for Configuring Business Entity Search Logic

(76) Inventors: Craig Ronald Van Roy, Los Gatos, CA (US); Thomas Alan Karnatz, JR., Raleigh, NC (US); Claudia Rodica Charlier, Garner, NC (US)

(21) Appl. No.: 13/271,887

(22) Filed: Oct. 12, 2011

Related U.S. Application Data
(60) Provisional application No. 61/392,717, filed on Oct. 13, 2010.

(51) Int. Cl. G06F 7/00; G06F 17/00

(52) U.S. Cl. 707/694; 707/E17.005

(57) ABSTRACT

A system for generating a business name normalization configuration used by a secretary of state office to process a business name search is disclosed. The system includes a user interface that enables a user to create or edit the business name normalization configuration by displaying a plurality of business name normalization characteristics and receiving a plurality of selections corresponding to the characteristics. The system stores the business name normalization characteristics and selections so as to define the business name normalization configuration, wherein the business name normalization configuration provides a set of rules for normalizing each of a plurality of business names. The business name normalization configuration is then used to normalize registered names and a query name. The normalized registered names and normalized query name are compared, and the registered names corresponding to the normalized registered names that are identical to the normalized query name are displayed as search results.

### CROSS-REFERENCE TO RELATED APPLICATIONS

This application is based on and claims priority to U.S. Provisional Application Ser. No. 61/392,717, filed on Oct. 13, 2010, which is incorporated herein by reference in its entirety.

### STATEMENT REGARDING FEDERALLY SPONSORED RESEARCH OR DEVELOPMENT

Not applicable.

### BACKGROUND OF THE INVENTION

Various entities, including corporations, limited liability corporations, professional corporations, not-for-profit corporations, financial institutions, cooperatives, and benevolent entities, register their names with a secretary of state office and other governmental agencies. These registered names may include the official name of the entity, fictitious names, “doing business as” or “d/b/a” names, and trade names, which are evidenced by documents filed by the entity at the time of registration. It is not uncommon for a secretary of state office to maintain an electronic database of all the names registered with that office in association with information about the underlying entities. Ideally, this database can be searched for two primary purposes—to locate information about a specific registered entity and to determine whether a proposed new entity name has already been registered. When attempting to locate a specific registered entity, the searcher often does not know the exact official name of the entity for which she is looking. For example, if the searcher enters “Town,” but the registered name is “The Town Bistro,” no results will be returned. When checking whether a proposed new name is available for registration, the same problem may occur in that only exact matches are returned and the searcher is unable to view names close to the proposed new name that was searched. Current software used by secretary of state offices to search business name databases may have a limited number of search options hard coded into the software application that will permit search results other than exact matches to be returned. To appropriately use these options, a user must have an understanding of how the search strategy works when one or more of the options are employed, otherwise the search results may be over or under inclusive. Moreover, a secretary of state office may want to vary the stringency with which the search is conducted, i.e., how similar the search results are to the queried name, for various purposes and depending on the number of registered names in the database. Search logic that has been hard coded into the software cannot accommodate an office, such as a secretary of state office, where it is desirable to re-configure the search logic and the stringency it imposes on the search on the fly.

### BRIEF SUMMARY OF THE INVENTION

A method and system for generating a business name normalization configuration used by a secretary of state office or other government agency to process a business name search is disclosed. The business name normalization configuration defines the business name search logic in that it modifies the business name by replacing or removing common words or characters that appear in many business names. By replacing a variety of common words or characters with a single word or character, such as replacing all “#” and “no.” characters with the word “number,” or removing common words or characters from the names altogether, the unique portions of the business names are compared during a search.

In one aspect of the invention, a server is used to create or edit a business name normalization configuration by displaying a plurality of business name normalization characteristics and receiving a user's selection for each characteristic. The business name normalization characteristics and corresponding selections are stored in a database server so as to define the business name normalization configuration. The business name normalization configuration provides a set of rules for normalizing each of the business names.

Preferably, the rules are a combination of replacement rules and noise rules. For a replacement rule, the business name normalization characteristics include a priority number, a target character(s), a target character(s) location, a replacement character(s), and an activation option. When the replacement rule is applied, the server replaces the target character(s) in the business name with the replacement character(s) to create a normalized business name. For a noise rule, the business name normalization characteristics include a priority number, a noise character(s), a noise character(s) location, and an activation option. When the noise rule is applied, the server removes the noise character(s) from the business name to create a normalized business name. The normalized registered names are stored in association with their corresponding registered names in a data storage device.

In another aspect of the invention, a server is used to search the registered names stored in the data storage device. Registered names are normalized using the rules defined by the business name normalization configuration as described above. The server enables a user to initiate a business name search by receiving a query name and receiving an input to initiate the search. The business name normalization configuration is applied to the query name to create a normalized query name. The server then compares the normalized query name to the normalized registered names, and the registered names associated with the normalized registered names that are identical to the normalized query name are displayed as search results.

For example, in the replacement rule example first given above, the characters “no.” and “#” are replaced with the word “number.” If a noise rule for the same business name normalization configuration is also configured to remove the word “The” when it appears at the beginning of a name, then the following could occur. A registered name “No. Crunchers” would be normalized to “Number Crunchers” when the business name normalization configuration is applied because the “No.” character would be replaced with “Number.” In a similar fashion, a query name “The # Crunchers” would be normalized to “Number Crunchers” when the business name normalization configuration is applied because the “#” character would be replaced with “Number” and the word “The” would be removed because it appears at the beginning of the name. Thus, a search for “The # Crunchers” would return the result “No. Crunchers” using the business name normalization configuration described above in accordance with the present invention.

### BRIEF DESCRIPTION OF THE DRAWINGS

FIG. 1 is a diagram of a system for configuring business entity search logic in accordance with an exemplary embodiment of the present invention.

FIG. 2 is a process flow diagram of a method for configuring a business name normalization configuration using the system of FIG. 1 in accordance with an exemplary embodiment of the present invention.

FIGS. 3-6 are exemplary screen shots of a display device of FIG. 1 during the business name normalization configuration process.

FIG. 7 is a process flow diagram of a method of creating normalized registered names using a business name normalization configuration.

FIG. 8 is a process flow diagram of a method of searching registered names and displaying search results using a business name normalization configuration.

### DETAILED DESCRIPTION OF PREFERRED EMBODIMENT

The present invention is directed to a system and method for configuring a business name normalization configuration used to process a search for registered names stored in a database. A secretary of state office may collect information about business entities when they register to do business in the state, file documents, or otherwise interact with the office. A variety of entities, including corporate entities, not-for-profit entities, cooperatives, financial institutions, and benevolent entities, are tracked by secretary of state offices in this manner. The collected information includes one or more registered names. As used throughout this specification, “registered name” refers to the official name of an entity or other names associated with that entity, including but not limited to legal names, fictitious names, “doing business as” or “d/b/a” names, home state names, foreign registered names, trade names, reserved names, assumed business names, forced d/b/a names, or state chartered names. Of course other types of names may be associated with a particular entity depending on the agency or organization compiling the information. It should be understood that a name may comprise a single word or combination of words, a single letter or combination of letters, a single number or combination of numbers, a single symbol or combination of symbols, a single character or combination of characters, one or more spaces, or a combination of any one or more of words, letters, numbers, symbols, characters, and spaces.

Search applications that permit a user to search for a business entity by name must be capable of returning search results that not only are identical, but also similar, to the query name because often the user does not enter the exact registered name as the query name. As used throughout the specification, “query name” refers to the name entered by the user when searching for a business entity in the database and “business name” refers to both registered names and a query name. To enable the application to return relevant results that are identical or similar to the query name, the search logic of the present invention includes a business name normalization configuration that defines rules for normalizing the registered names and query names. The business name normalization configuration can be created and edited by a user without requiring the user to have expertise in software code, configuration files, or relational database systems. While the invention will be described in detail below with reference to an exemplary embodiment, it should be understood that the invention is not limited to the specific system configuration or methodology of this embodiment. In addition, although the exemplary embodiment is described as embodying several different inventive features, one skilled in the art will appreciate that any one of these features could be implemented without the others in accordance with the invention.

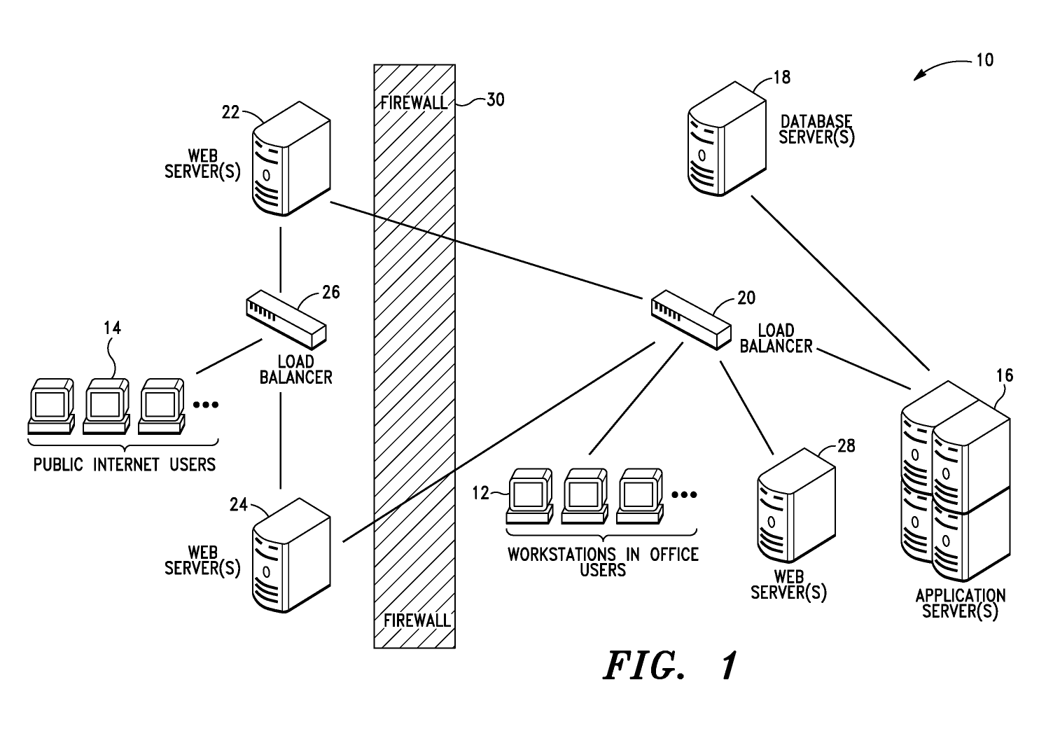

Referring to FIG. 1, an exemplary system used to create and edit business name normalization configurations in accordance with an exemplary embodiment of the present invention is generally indicated by reference numeral 10. System 10 includes one or more workstations 12 for use by workers located in an office, such as a secretary of state office. Workstations 12 may comprise any suitable computing system (such as a programmed general purpose computer, a special purpose computer, or the like). One or more peripheral devices may also be provided, such as a display device, a standard keyboard, a mouse, a scanner, a barcode reader, a magnetic stripe reader, and/or a printer. System 10 may also include computers 14 used by external workers or other users who are permitted to access the system from a remote location using public internet and VPN technologies known in the art.

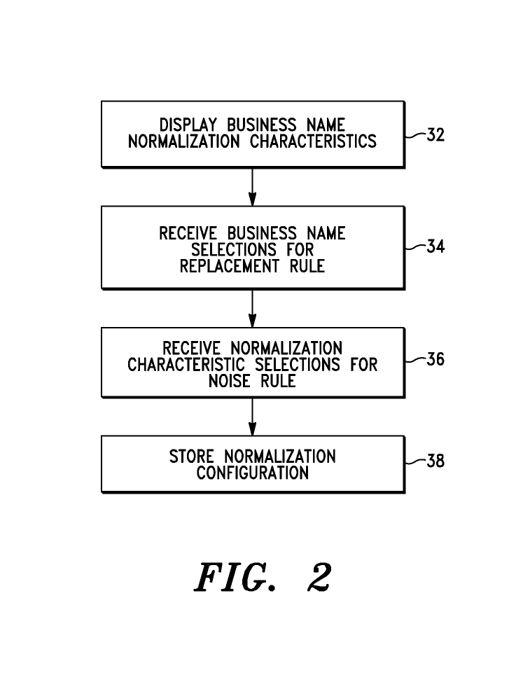

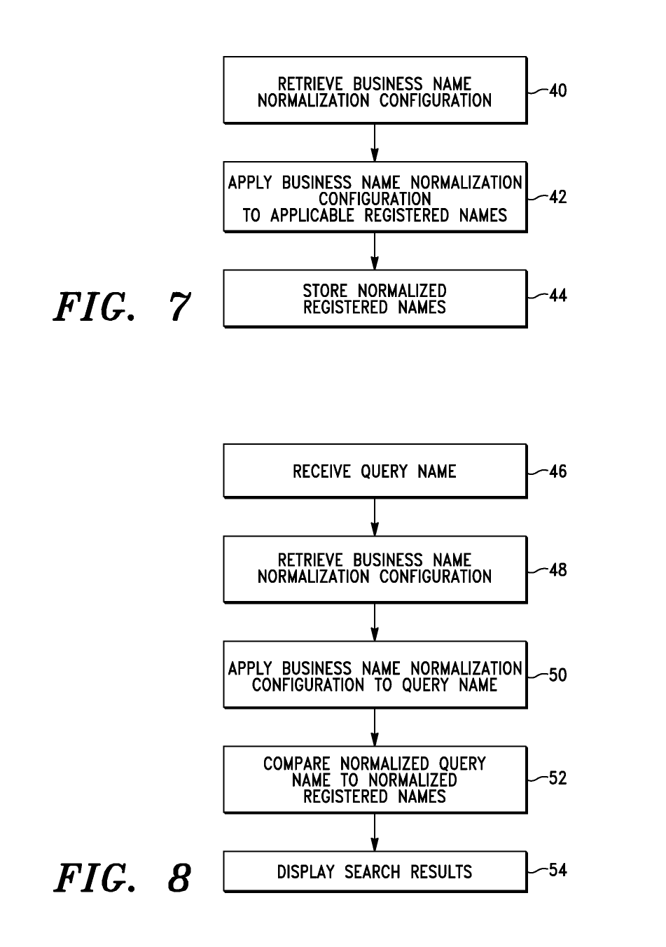

System 10 also includes one or more centralized application servers 16 each of which hosts and runs one or more applications in accordance with the present invention. One application server is used to create and edit a business name normalization configuration, as described below with reference to FIGS. 2-6. The same application server or another application server is used to apply the business name normalization configuration to the business names as described below with reference to FIG. 7. Finally, the same application server or another application server is used to search the registered names using a query name as described below with reference to FIG. 8. For simplicity, the term “application server” as used herein means both the hardware (i.e., any computing device in which a processor is operable to execute computer-readable instructions stored on a non-transitory computer-readable medium) and the application(s) that reside thereon.

System 10 further includes one or more centralized database servers 18 each of which stores various types of data, such as business name normalization configurations (discussed below), registered names, normalized or partially normalized registered names, and other information associated with a business entity, including, but not limited to, authorized/registered agent, information related to business names such as registration/reservation dates, business identification numbers and codes, formation details, withdrawal or dissolution information, partners/officers/directors/owners/managers/members, filings performed, payments and other financial transactions, trademarks, complaints, written correspondence, comments/notes, principal place of business, and/or articles of incorporation. For simplicity, the term “database server” as used herein means both the hardware (i.e., any data storage device or memory operable to store and provide access to data) and the data stored therein. It should be understood that the data may be stored in a database or any other type of data storage device or structure known in the art. For example, all or a portion of the data may be stored as a variable on the system in files of various types, such as XML files, flat files, fixed length files, delimited files, batch files, application configuration files, and a wide variety of other file types known in the art.

Several types of computer network connections may be used to network the various components of system 10, including a local area network (LAN), a wide area network (WAN), and other network topologies known in the art. In the illustrated example, application servers 16 are directly connected to database servers 18. A load balancer/router 20 functions to route network traffic between workstations 12 and web servers 28 and between application servers 16 and web servers 28. In addition, remote computers 14 located outside of the network may access application servers 16 through external web servers 22 and 24 and a load balancer/router 26 through any suitable firewall 30. Alternatively, remote computers 14 could access application servers 16 directly through firewall 30 (via an appropriate network configuration), through a series of external web servers, through a VPN connection, or through any other technologies known in the art.

System 10 described above and shown in FIG. 1 is merely an example of a network architecture that may be used to implement the present invention. One skilled in the art will understand that other network architectures may also be used, including a more decentralized model in which the application server(s) and/or database server(s) are only accessible from specific workstations or where the functionality is distributed so that it actually resides on the client workstations in a client application type of model. Also, the application servers and database servers may be replaced with one or more servers that perform both the application and data storage functions described above. Thus, the system may be implemented with any number of servers without departing from the scope of the present invention.

Referring now to FIG. 2, a process flow diagram that shows an exemplary method of creating or editing a business name normalization configuration using system 10 of FIG. 1 is provided. As will be described in greater detail below, the business name normalization configuration is used to facilitate searching for business entities by name through a process of normalizing both the query name (i.e., the name input by the user performing the search) and the registered names stored in database servers 18. Preferably, the business name normalization configuration is initially created by a client administrator so that the configuration is in accordance with system structure and organization policy, rules, and goals with respect to the degree of similarity between the query name and the registered names returned in the search results. As the organization's policies, rules, or goals change, the business name normalization configuration may be edited to reflect those changes at any time without requiring direct modifications to the software code.

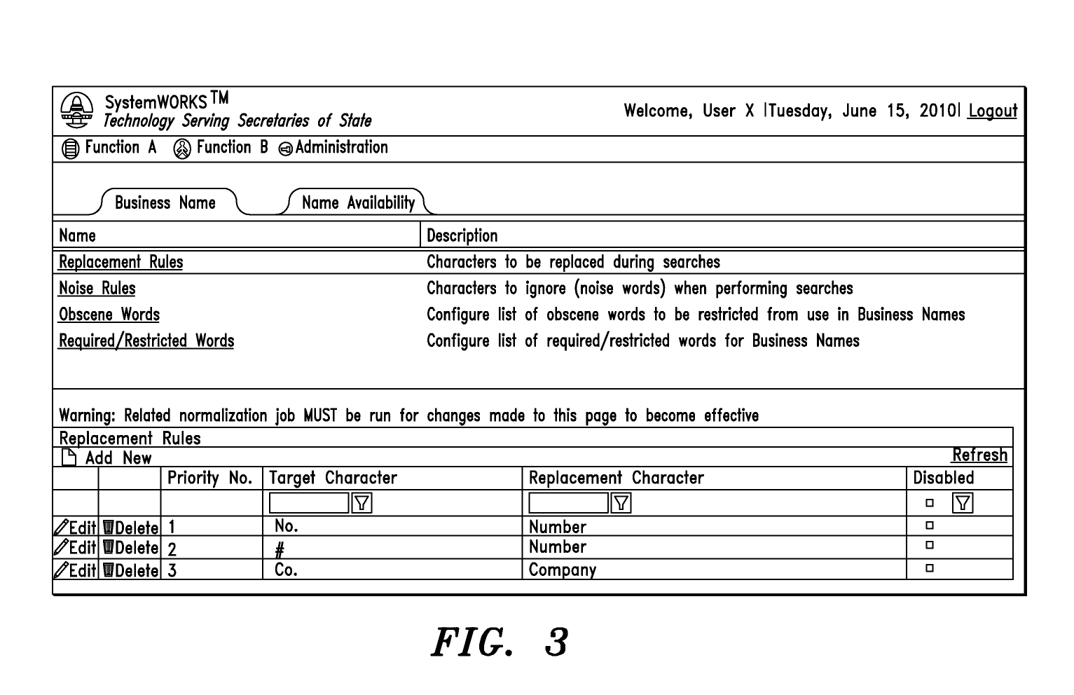

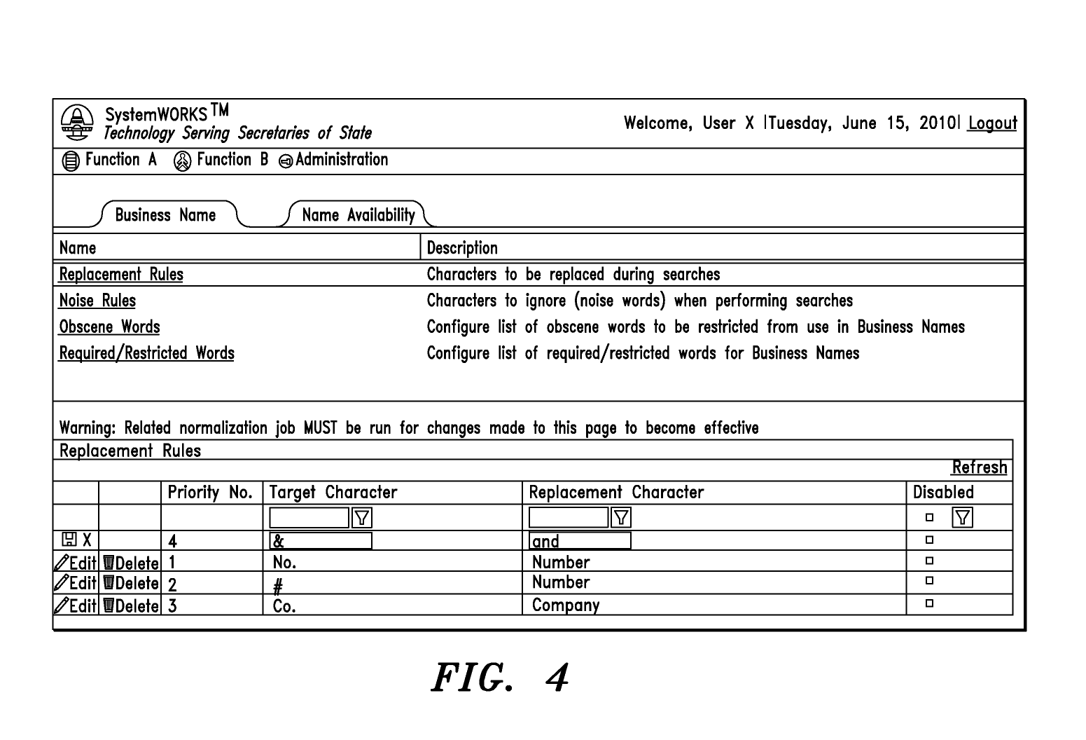

At block 32, system 10 (via one of workstations 12 or remote computers 14) displays business name normalization characteristics for a business name configuration. An exemplary screen that is displayed on the administrator's display is shown in FIG. 3. Tabs across the top of the screen, including “Business Name” and “Name Availability,” permit the administrator to toggle between the business name normalization configurations under each tab. If only one configuration is stored under a tab, the business name normalization characteristics for that configuration are displayed as shown in FIG. 3. If more than one configuration is stored, a summary of all the stored business name normalization configurations may be provided in a list format. Such a summary may include the name of each configuration and a short description of its purpose. The ability to browse through stored business name normalization configurations is particularly useful when providing clients with pre-configured, common configurations. To create a new business name normalization configuration, the client administrator can select an “Add New” button; to edit an existing business name normalization configuration, the client administrator can select an “Edit” button associated with the existing configuration. Whether the “Edit” or “Add New” button is used, the business name normalization configuration characteristics will be displayed in a similar fashion to those shown in FIGS. 3 and 4. The business name normalization configurations for each type (business name or name availability) are stored in database servers 18 using software residing on application servers 16. The configuration process will be described in detail below with respect to a “Business Name” normalization configuration. It should be noted that throughout this specification, the term “button” is used in a general sense to indicate a word, icon or graphic that, when actuated, causes the performance of an action or opens another screen for viewing. Alternatively, other means may be used to execute the desired function, such as a hyperlink, voice command, or set of keyboard commands.

With reference to FIG. 2 at block 34, the administrator begins to configure the business name normalization configuration by formulating replacement rules that identify target characters, i.e., one or more characters in a name to be replaced and their corresponding replacement character(s). An exemplary screen displaying the replacement rules on the administrator's display is shown in FIG. 3. The screen shown is divided into a top half and a bottom half. The top half lists various types of rules that may be used by the administrator to configure the normalization configuration. In FIG. 3, “Replacement Rules” is selected in the top half of the screen and the bottom half of the screen displays a table of the replacement rules that have been previously configured.

With further reference to FIG. 3, the table includes a row for each replacement rule. In each row, characteristics of the replacement rule, such as a priority number (indicating in what order each replacement rule is applied relative to the other replacement rules), the target character(s), and the replacement character(s), are shown. It should be understood that a target character or a replacement character may comprise a single word or combination of words, a single letter or combination of letters, a single number or combination of numbers, a single symbol or combination of symbols, one or more spaces, or a combination of any one or more of words, letters, numbers, symbols, spaces and any other character type. The table also includes a check box indicating whether the particular replacement rule is active or disabled. In the exemplary screen of FIG. 3, the abbreviation “No.” has been configured to be replaced with the word “Number,” the “#” symbol has been configured to be replaced with the word “Number,” and the abbreviation “Co.” has been configured to be replaced with the word “Company.” Pursuant to the priority number associated with each replacement rule in the “Priority No.” column, the “No.” replacement will occur first, then the “#” symbol replacement, and then the “Co.” replacement. To change the order of replacement, the administrator may highlight a row and drag and drop it above or below another row. The values in the “Priority No.” column will adjust accordingly to indicate the new order. Alternatively, the administrator may edit the values in the “Priority No.” column manually to designate a new order in which the rules are applied.

Adding a new replacement rule is accomplished by selecting the “Add New” button shown in FIG. 3. An exemplary screen that may be displayed on the administrator's display after the “Add New” button is selected is shown in FIG. 4. As can be seen, the priority number is automatically populated with the next available number, text boxes are provided under the “Target Character” and “Replacement Character” columns, and a checkbox is provided under the “Disabled” column. The administrator then inputs the character(s) that she desires to be replaced in the “Target Character” text box, inputs the replacement character(s) in the “Replaced Replacement Character” text box, and checks (or unchecks) the box in the “Disabled” column. As shown in FIG. 4, the administrator has configured an ampersand symbol (“&”) to be replaced with the word “and.” After configuring the replacement rule, the administrator saves the replacement rule by selecting the save button. Once saved, the new replacement rule will appear in the table as row No. 4. As discussed above, the order of replacement may be changed at any time by dragging and dropping each replacement row into a new desired position.

Examples of common replacement rules are provided in the table below:

| TARGET CHARACTER | REPLACEMENT CHARACTER |
|---|---|
| & | and |
| @ | at |
| % | percent |
| = | equals |
| 3 | cubed |
| 2 | squared |
| # | number |
| No. | number |
| Inc | incorporated |
| Inc. | incorporated |
| Co | company |
| Co. | company |
| LLP | limited liability partnership |
| L.L.P. | limited liability partnership |
| LLC | limited liability company |
| L.L.C. | limited liability company |
| PC | professional corporation |
| P.C. | professional corporation |

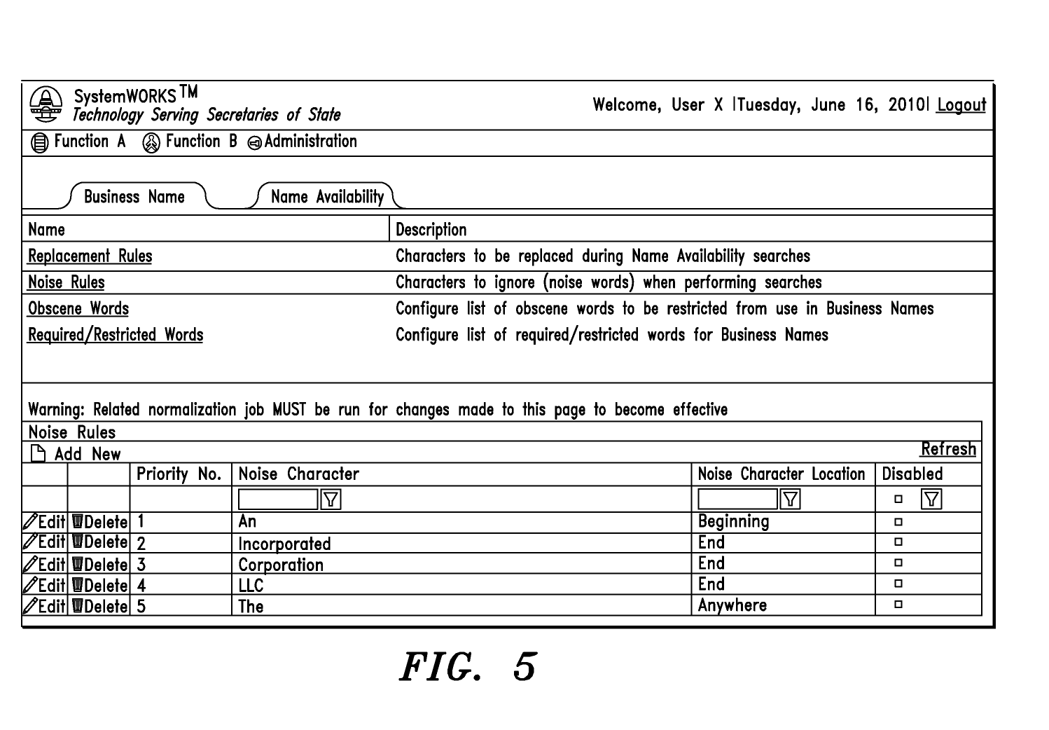

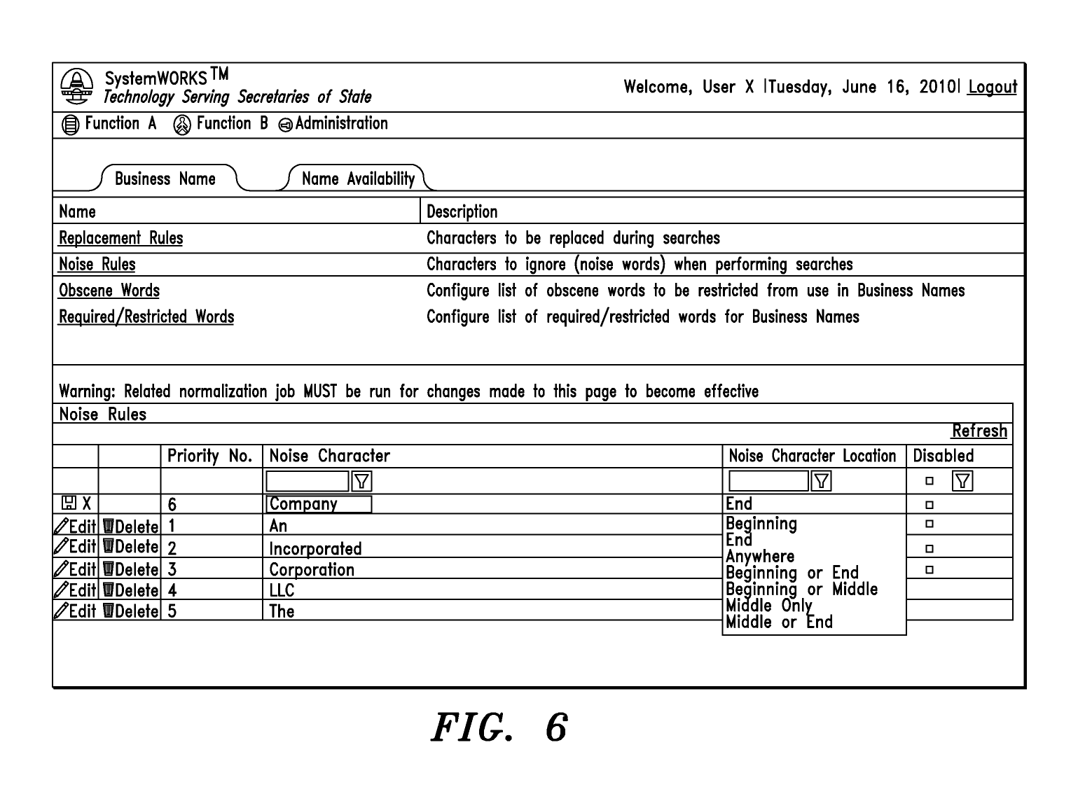

One skilled in the art will appreciate that it is possible to configure a replacement rule in which the character(s) are replaced with nothing (i.e., an empty field). This type of replacement rule would effectively remove the character(s) from a name. Alternatively, the removal of character(s) from a name may be accomplished via the use of the noise feature, discussed below in connection with FIGS. 5 and 6. It is also possible to configure a replacement rule by specifying the location of the character(s) to be replaced as shown in FIGS. 5 and 6 and described below with reference to the noise rules. For example, a replacement rule could be configured to replace the abbreviation “Co.” with the word “Company” only if the abbreviation “Co.” appears at the end of a name. Other types of replacement rules will become apparent to one skilled in the art.

With reference to FIG. 2 at block 36, the administrator may further configure the business name normalization configuration by formulating noise rules that identify noise words or characters in a name to be ignored during the search by removing them from the normalized name. An exemplary screen displaying the noise rules on the administrator's display is shown in FIG. 5. Similar to the screen in FIG. 3, the screen in FIG. 5 is divided into a top half and a bottom half. The top half lists various rules that may be used by the administrator to configure the normalization configuration. In FIG. 5, “Noise Rules” is highlighted on the top half of the screen and the bottom half of the screen displays a table of the noise rules that have been previously configured by the administrator.

As shown in FIG. 5, the table includes a row for each noise rule. In each row, business name normalization configuration characteristics for noise rules, such as a priority number (indicating in what order the noise rule is implemented), the noise character, and the noise character location, are provided. It should be understood that a noise character may comprise a single word or combination of words, a single letter or combination of letters, a single number or combination of numbers, a single symbol or combination of symbols, one or more spaces, or a combination of any one or more of words, letters, numbers, symbols, spaces, and any other character type. The table also includes a check box indicating whether the particular noise rule is active or disabled. For example, as shown in FIG. 5, the word “An” is removed if it appears at the beginning of a name, the word “The” is removed if it appears anywhere in a name, and the words “Incorporated” and “Corporation” and the abbreviation “LLC” are removed if they appear at the end of a name. Pursuant to the number associated with each noise rule in the “Priority No.” column, the word “An” will be ignored first, then the word “Incorporated,” then the word “Corporation,” then the abbreviation “LLC,” and then the word “The.” To change the order in which the noise words are removed, the administrator may drag and drop the noise rule rows into the desired order.

Adding a new noise rule is accomplished by selecting the “Add New” button shown in FIG. 5. An exemplary screen that may be displayed on the administrator's display after the “Add New” button is selected is shown in FIG. 6. As can be seen, the noise rule implementation order number is automatically populated with the next available number, a text box is provided under the “Noise Character” column, a dropdown menu box is provided in the “Noise Character Location” column, and a checkbox is provided under the “Disabled” column. The administrator then inputs a word or characters to be ignored in the “Noise Character” text box, selects a position from the “Noise Character Location” dropdown menu, and checks (or unchecks) the box in the “Disabled” column. The “Noise Character Location” dropdown menu includes the options “beginning,” “end,” and “anywhere,” and may also include further options such as “beginning or end,” “beginning or middle,” “middle only,” and “middle or end.” As shown in FIG. 6, the administrator has identified the word “Company” as a noise character and has configured the business name normalization configuration to remove the word in the normalized business name when it appears at the end of a business name. The administrator may save the new noise rule by selecting a save button. Once saved, the new noise rule will appear in the table as row No. 6. As discussed above, the order in which the designated words and characters are ignored may be changed at any time by dragging and dropping the appropriate row into a new desired position.

Examples of some common noise rules are provided in the table below:

| | NOISE |
|---|---|
| | CHARACTER |
| NOISE CHARACTER | LOCATION |
| [space] | Anywhere |
| ' | Anywhere |
| - | Anywhere |
| ! | Anywhere |
| # | Anywhere |
| $ | Anywhere |
| % | Anywhere |
| & | Anywhere |
| ( | Anywhere |
| ) | Anywhere |
| * | Anywhere |
| , | Anywhere |
| . | Anywhere |
| / | Anywhere |
| : | Anywhere |
| ; | Anywhere |
| ? | Anywhere |
| @ | Anywhere |
| [ | Anywhere |
| \ | Anywhere |
| ] | Anywhere |
| \hat{ } | Anywhere |
| _ | Anywhere |
| \grave{ } | Anywhere |
| { | Anywhere |
| \| | Anywhere |
| } | Anywhere |
| ~ | Anywhere |
| + | Anywhere |
| < | Anywhere |
| = | Anywhere |
| > | Anywhere |
| a corporation | End |
| agency | End |
| an | Beginning |
| and | Anywhere |
| as trustee | End |
| assc | End |
| assn | End |
| assoc | End |
| associates | End |
| association | End |
| at | End |
| attorneys at law | End |
| bank | End |
| business trust | End |
| cu | End |
| charter | Middle |
| chartered | Middle |
| co | End |
| company | End |
| corp | End |
| corporation | End |
| credit union | End |
| cu | End |
| dr | Beginning |
| f c u | End |
| f s b | End |
| fcu | End |
| federal credit union | End |
| federal savings bank | End |
| fsb | End |
| g p | End |
| gen part | End |
| general partnership | End |
| gp | End |
| inc | End |
| incorporated | End |
| l c | End |
| l l c | End |
| l l p | End |
| l p | End |
| l t d | End |
| lc | End |
| limited | Anywhere |
| limited liability co | End |
| limited liability company | End |
| limited liability partnership | End |
| limited partnership | End |
| llc | End |
| llp | End |
| lp | End |
| ltd | End |
| ltd liability company | End |
| m d p a | End |
| m d p c | End |
| mdpa | End |
| mdpc | End |
| medical doctors professional assn | End |
| medical doctors professional association | End |
| medical doctors professional corp | End |
| medical doctors professional corporation | End |
| mr | Beginning |
| mrs | Beginning |
| ms | Beginning |
| n a | End |
| na | End |
| national association | End |
| national bank | End |
| p a | End |
| p c | End |
| p l l c | End |
| pa | End |
| partners | End |
| partnership | End |
| pc | End |
| pllc | End |
| prof assn | End |
| prof corp | End |
| prof corporation | End |
| professional association | End |
| professional corp | End |
| professional corporation | End |
| professional limited liability co | End |
| professional limited liability company | End |
| rllp | End |
| railroad | End |
| real estate investment trust | Middle |
| registered limited liability partnership | End |
| reit | End |
| r l l p | End |
| rr | End |
| s a | End |
| s c | End |
| s p | End |
| s p a | End |
| sa | End |
| savings association | End |
| sc | End |
| service corporation | End |
| sole proprietorship | End |
| sp | End |
| spa | End |
| the | Anywhere |
| trust | End |
| trustee | End |
| u s a | Middle |
| u.s.a | End |
| usa | End |

Although the exemplary screen shots shown in FIGS. 3-6 present the replacement rules and noise rules in a table format, other methods may be implemented. For example, a series of yes/no questions relating to the activation/disablement of each replacement rule and noise rule may be provided. In addition, a series of commonly used replacement rules and noise rules may be pre-configured and provided at the outset to the administrator. Other implementations will be apparent to one skilled in the art. Of course, the order in which the replacement rules and noise rules are configured can vary as well. An administrator may prefer to configure all the replacement rules first or all the noise rules first or may toggle between the replacement rules and the noise rules as she designs the normalization configuration strategy. It should also be understood that any method known in the art for displaying any of the business name normalization characteristics and receiving business name normalization characteristic selections may be used. For example, a business name normalization configuration characteristic may be displayed in association with a text box, in which case the selection is a text entry entered by a user in the text box (as described above with reference to the target character, replacement character, and noise word). A business name normalization characteristic may also be displayed in association with a checkbox, in which case the selection is a check entered by a user in the checkbox (similar to what is described above with reference to the “Disabled” option). In addition, a business name normalization characteristic may be displayed in association with one or more pre-determined options, in which case the selection is a selection made by a user form the pre-determined options (as described above with reference to the “Noise Character Location”). Other selection methods may include marking a radio button, actuating a button, or selecting indicators such as “yes” or “no,” or “on” or “off” for each business name normalization characteristic.

With reference to FIG. 2 at block 38, the administrator saves the business name normalization configuration by selecting a save button once all the desired replacement and/or noise rules have been configured. The business name normalization configuration is then ready to be applied to business names. Based on the description above, it can be appreciated that the order in which the replacement rules and noise rules are implemented may affect the normalized version of a name. For example, a replacement rule may be configured to replace the abbreviation “Co.” with the word “Company,” and a noise rule may be configured to remove the word “Company” if it appears at the end of a name. If the replacement rule is implemented prior to the noise rule, then the abbreviation “Co.” will be replaced with the word “Company” (per the replacement rule) and then the word “Company” will be removed if it appears at the end of the name (per the noise rule). Thus, neither the abbreviation “Co.” nor the word “Company” will appear in the normalized name. However, if the noise rule is implemented prior to the replacement rule, then there will be no removals (per the noise rule) and the abbreviation “Co.” will be replaced with the word “Company” (per the replacement rule). Thus, the word “Company” will appear in the normalized name. Preferably, the administrator is required to designate the order in which the replacement rules and noise rules are implemented in order to avoid inconsistent results. Alternatively, the replacement rules and noise rules with respect to the registered names could be implemented at different times, which will necessarily dictate the order in which the rules are implemented. For example, the replacement rules may be implemented upon saving a new business name normalization configuration (whereby the partially normalized registered names are stored in database servers 18, as discussed below) and the noise rules may be implemented each time a search is performed (or vice versa). Of course it is also possible that only the noise rules or replacement rules (but not both) are implemented such that order is not an issue.

With reference to FIG. 7, a process flow diagram that shows an exemplary method of normalizing the registered names stored in database servers 18 using system 10 of FIG. 1 is provided. At block 40, the business name normalization configuration is retrieved by application servers 16. With reference to block 42, the business name normalization configuration is applied to the registered names stored in database servers 18 to create the normalized registered names. With reference to block 44, the normalized registered names are stored in database servers 18 in association with the corresponding registered names. Preferably, all of the registered names stored in database servers 18 are automatically normalized at the time that the business name normalization configuration is saved. A “Normalize Now” button may also be provided on a client administrator's display such that the normalization process may be manually initiated at any time. Of course, if the business name normalization configuration is modified at any time, then the registered names are normalized again using the modified business name normalization configuration, and the new normalized registered names are stored in database servers 18 in association with the registered names. The normalization process may occur automatically upon saving the edited configuration or initiated manually as described above. Once a business name normalization configuration has been saved, it is also possible that each time a new registered name is added to database servers 18, the normalized registered name is automatically or manually created and stored in association with the registered name. In addition to or instead of the manual and automatic normalization options described above, the normalization process could be set to automatically occur at a regularly scheduled time (e.g., at an early morning time when the traffic on the servers is typically low). This ensures that all the latest changes to the business name normalization configuration have been applied to create the appropriate normalized registered names. Alternatively, the normalized registered names for all of the registered names could be generated using the most updated configuration each time a search is performed. The dynamic ability to re-configure or edit business name normalization configurations, as described above, allows client administrators to update or change the way searches are performed, for example, in response to changes in law, policy, or search goals, without waiting for a new version of the software application.

Finally, the business name normalization configuration is used to facilitate searches for business entities by name. With reference to FIG. 8, a process flow diagram that shows an exemplary method of searching registered names and displaying search results using a business name normalization configuration using system 10 of FIG. 1 is provided. At block 46, an application server (16) receives a query name along with an input to initiate the search from a user. With reference to blocks 48 and 50, the normalization configuration is retrieved and applied to the query name in a similar manner to that described above with reference to blocks 40 and 42 in FIG. 7. With further reference to FIG. 8, block 52, the search application compares the normalized query name to the normalized registered names to identify one or more identical matches. With reference to block 54, the registered names associated with the normalized registered names that are identical to the normalized query name are displayed as search results.

An example is provided using the replacement rules and noise rules discussed above in connection with FIGS. 3-6 (and assuming that the replacement rules are implemented prior to the noise rules). If “Jack & Jill's Number 1 Landscaping Company” is a registered business name, then the normalized registered name will be “Jack and Jill's Number 1 Landscaping.” This normalized registered name is generated by replacing the character “&” with the word “and” (per the replacement rule shown in FIG. 4, row 4), and the word “Company” is removed because it appears at the end of the name (see noise rule shown in FIG. 6, row 6). When a user searches for registered names, she may enter the name “The Jack and Jill's No. 1 Landscaping Corporation” as the query name. The normalized query name will be “Jack and Jill's Number 1 Landscaping.” This normalized query name is generated by replacing the abbreviation “No.” with the word “Number” (per the replacement rule shown in FIG. 4, row 1), the word “The” is removed because it appears anywhere in the queried name (per the noise rule shown in FIG. 6, row 5), and the word “Corporation” is removed because it appears at the end of the queried name (per the noise rule shown in FIG. 6, row 3). Thus, the normalized registered name is identical to the normalized queried name such that the registered name “Jack & Jill's Number 1 Landscaping Company” will be returned as a search result for the query name “The Jack and Jill's No. 1 Landscaping Corporation.” As a result, the search application returns search results that are similar to the query name and not just an identical match to the query name. While in the exemplary embodiment the business entity search is only based on names, search results could be filtered by other search criteria including but not limited to business entity status (such as active/compliant, dissolved, or canceled), business entity type (such as bank, business corporation, or cooperative), business entity category (such as active or inactive), or business name type (such as legal, foreign, or trade name). One or more of these criteria may be used in conjunction with a business name search to vary the scope of the search results returned.

While the present invention has been described and illustrated hereinabove with reference to an exemplary embodiment, it should be understood that various modifications could be made to this embodiment without departing from the scope of the invention. For example, the ability to create and edit business name normalization configurations may be used in connection with searches for a proposed business entity name (i.e., to determine whether the name is available for registration), which could be implemented under the “Name Availability” tab shown in FIG. 3. These types of searches will require consideration of rules and regulations governing appropriate business entity names, including rules regarding obscene words, required words and/or restricted words. Accordingly, one skilled in the art will appreciate that the present invention may be used to facilitate a variety of different types of searches related to business names. Therefore, the present invention is not to be limited to the exemplary embodiment described and illustrated hereinabove, except insofar as such limitations are included in the following claims.

What is claimed and desired to be secured by Letters Patent is as follows:

1. A non-transitory computer-readable medium having instructions stored thereon for execution by a processor to perform a method for generating a business name normalization configuration used by a secretary of state office to process a business name search, said method comprising:
displaying a plurality of business name normalization characteristics;
receiving a plurality of selections corresponding to said business name normalization characteristics; and
storing said business name normalization characteristics and said corresponding selections in a data storage device so as to define said business name normalization configuration, wherein said business name normalization configuration provides a set of rules for normalizing each of a plurality of business names.

2. The non-transitory computer-readable medium of claim 1, said method further comprising applying said business name normalization configuration to one or more of said business names to create a plurality of corresponding normalized business names.

3. The non-transitory computer-readable medium of claim 1, wherein said business names comprise a plurality of registered names stored in said data storage device.

4. The non-transitory computer-readable medium of claim 1, wherein said business names comprise at least one query name.

5. The non-transitory computer-readable medium of claim 2, said method further comprising storing said normalized business names in association with said corresponding business names in said data storage device.

6. The non-transitory computer-readable medium of claim 2, wherein one or more of said rules comprise a replacement rule and said business name normalization characteristics for said replacement rule comprise one or more of the following: a priority number, a target character, a target character location, a replacement character, and an activation option.

7. The non-transitory computer-readable medium of claim 6, wherein said applying step further comprises replacing said target character in each of said business names with said replacement character to create said normalized business names.

8. The non-transitory computer-readable medium of claim 2, wherein one or more of said rules comprise a noise rule and said business name normalization characteristics for said noise rule comprise one or more of the following: a priority number, a noise character, a noise character location, and an activation option.

9. The non-transitory computer-readable medium of claim 8, wherein said applying step further comprises removing said noise character from each of said business names to create said normalized business names.

10. The non-transitory computer-readable medium of claim 1, wherein said method further comprises displaying one or more pre-determined options associated with at least one of said business name normalization characteristics.

11. The non-transitory computer-readable medium of claim 10, wherein at least one of said selections comprises a selection made by a user from said pre-determined options.

12. The non-transitory computer-readable medium of claim 1, wherein said method further comprises displaying a text box associated with at least one of said business name normalization characteristics.

13. The non-transitory computer-readable medium of claim 12, wherein at least one of said selections comprises a text entry entered by a user in said text box.

14. The non-transitory computer-readable medium of claim 1, wherein said method further comprises displaying a checkbox associated with at least one of said business name normalization characteristics.

15. The non-transitory computer-readable medium of claim 14, wherein at least one of said selections comprises a check entered by a user in said checkbox.

16. The non-transitory computer-readable medium of claim 1, wherein said method further comprises displaying a summary comprising a list of said business name normalization configuration and at least one other business name normalization configuration.

17. The non-transitory computer-readable medium of claim 16, wherein said summary comprises a configuration name and a description of use for each of said business name normalization configurations on said list.

18. A non-transitory computer-readable medium having instructions stored thereon for execution by a processor to perform a method for processing a secretary of state office business name search using a business name normalization configuration, said method comprising:
generating a business name normalization configuration by:
displaying a plurality of business name normalization characteristics;
receiving a plurality of selections corresponding to said business name normalization characteristics;
storing said business name normalization characteristics and said corresponding selections in a data storage device so as to define said business name normalization configuration, wherein said normalization configuration provides a set of rules for normalizing a plurality of business names selected from the group consisting of one or more registered names and a query name;
normalizing said registered names:
applying said business name normalization configuration to said registered names to create a plurality of normalized registered names each corresponding to one of said registered names;
performing a business name search by:
receiving said query name;
applying said business name normalization configuration to said query name to create a normalized query name;
comparing said normalized query name to said normalized registered names; and
displaying said registered names associated with said normalized registered names that are identical to said normalized query name.

19. The non-transitory computer-readable medium of claim 18, further comprising storing said normalized registered names in association with said corresponding registered names in said data storage device.

20. The non-transitory computer-readable medium of claim 18, wherein one or more of said rules comprise a replacement rule and said business name normalization characteristics for said replacement rule comprise one or more of the following: a priority number, a target character, a target character location, a replacement character, and an activation option.

21. The non-transitory computer-readable medium of claim 20, wherein said applying steps further comprise replacing said target character in each of said registered names and said query name to create said normalized registered names and said normalized query name, respectively.

22. The non-transitory computer-readable medium of claim 18, wherein one or more of said rules comprise a noise rule and said business name normalization characteristics for said noise rule comprise one or more of the following: a priority number, a noise character, a noise character location, and an activation option.

23. The non-transitory computer-readable medium of claim 22, wherein said applying steps further comprise removing said noise character from each of said registered names and said query name to create said normalized registered names and said normalized query name, respectively.

24. The non-transitory computer-readable medium of claim 18, wherein said method further comprises displaying one or more pre-determined options associated with at least one of said business name normalization characteristics.

25. The non-transitory computer-readable medium of claim 24, wherein at least one of said selections comprises a selection made by a user from said pre-determined options.

26. The non-transitory computer-readable medium of claim 18, wherein said method further comprises displaying a text box associated with at least one of said business name normalization characteristics.

27. The non-transitory computer-readable medium of claim 26, wherein at least one of said selections comprises a text entry entered by a user in said text box.

28. The non-transitory computer-readable medium of claim 18, wherein said method further comprises displaying a checkbox associated with at least one of said business name normalization characteristics.

29. The non-transitory computer-readable medium of claim 28, wherein at least one of said selections comprises a check entered by a user in said checkbox.

30. The non-transitory computer-readable medium of claim 18, wherein said method further comprises displaying a summary comprising a list of said business name normalization configuration and at least one other business name normalization configuration.

31. The non-transitory computer-readable medium of claim 30, wherein said summary comprises a configuration name and a description of use for each of said business name normalization configurations on said list.

32. A system for generating a business name normalization configuration used by a secretary of state office to process a business name search, said system comprising:
at least one database server;
at least one application server in communication with said database server, wherein said application server:
provides a user interface that enables a user to create or edit said business name normalization configuration, wherein said user interface (i) displays a plurality of business name normalization characteristics and (ii) receives a plurality of selections corresponding to said business name normalization characteristics; and
stores said business name normalization characteristics and said corresponding selections in said database server so as to define said business name normalization configuration, wherein said business name normalization configuration provides a set of rules for normalizing each of a plurality of business names.

33. The system of claim 32, wherein said business names comprise one or more of the following: a plurality of registered names and a query name.

34. The system of claim 33, wherein said application server applies said business name normalization configuration to said registered names to create a plurality of normalized registered names.

35. The system of claim 34, wherein said application server stores said normalized registered names in association with said corresponding registered names in said database server.

36. The system of claim 34, wherein said user interface further enables said user to initiate a business name search, wherein said user interface (i) receives said query name and (ii) receives an input to initiate said search.

37. The system of claim 36, wherein said application server applies said business name normalization configuration to said query name to create a normalized query name and compares said normalized query name to said normalized registered names, and wherein said user interface displays said registered names associated with said normalized registered names that are identical to said normalized query name.

38. The system of claim 32, wherein one or more of said rules comprise a replacement rule and said business name normalization characteristics for said replacement rule comprise one or more of the following: a priority number, a target character, a target character location, a replacement character, and an activation option.

39. The system of claim 38, wherein said application server replaces said target character with said replacement character to create said normalized business names.

40. The system of claim 32, wherein one or more of said rules comprise a noise rule and said business name normalization characteristics for said noise rule comprise one or more of the following: a priority number, a noise character, a noise character location, and an activation option.

41. The system of claim 40, wherein said application server removes said noise character from said business names to create said normalized business names.

42. The system of claim 32, wherein said user interface displays one or more pre-determined options associated with at least one of said business name normalization characteristics.

43. The system of claim 42, wherein at least one of said selections comprises a selection made by a user from said pre-determined options.

44. The system of claim 32, wherein said user interface displays a text box associated with at least one of said business name normalization characteristics.

45. The system of claim 44, wherein at least one of said selections comprises a text entry entered by a user in said text box.

46. The system of claim 32, wherein said user interface displays a checkbox associated with at least one of said business name normalization characteristics.

47. The system of claim 46, wherein at least one of said selections comprises a check entered by a user in said checkbox.

48. The system of claim 32, wherein said method further comprises displaying a summary comprising a list of said business name normalization configuration and at least one other business name normalization configuration.

49. The system of claim 48, wherein said summary comprises a configuration name and a description of use for each of said business name normalization configurations on said list.

50. The system of claim 32, wherein said database server and said application server comprise a single server.
